(19) United States
(12) Patent Application Publication
(10) Pub. No.: US 2017/0139597 A1
(43) Pub. Date: May 18, 2017

(54) INFORMATION PROCESSING SYSTEM AND INFORMATION PROCESSING METHOD THEREOF

(71) Applicant: ELECTRONICS AND TELECOMMUNICATIONS RESEARCH INSTITUTE, Daejeon (KR)

(72) Inventor: Done Sik YOO, Daejeon (KR)

(21) Appl. No.: 15/046,146

(22) Filed: Feb. 17, 2016

(30) Foreign Application Priority Data
Nov. 13, 2015 (KR) 10-2015-0159880

(51) Int. Cl. G06F 3/06

(52) U.S. Cl. CPC G06F 3/0604; G06F 3/0631; G06F 3/067

(57) ABSTRACT

An information processing method includes receiving data comprising sensing information and an identifier from each of a plurality of sensing devices, obtaining profiles of the plurality of sensing devices from manufacturers of the plurality of sensing devices with reference to the identifier, storing metadata for the received data and the profiles in the data storage unit, and outputting the stored data comprising at least first data with reference to the metadata for the data stored in the data storage unit, wherein in the outputting of the stored data, a code is read from among a plurality of codes, second sensing information corresponding to second data has a code identical to the read code, and when the second data is stored in the data storage unit, the first and second data are output together, wherein the code is allocated to first sensing information corresponding to the first data.

### CROSS-REFERENCE TO RELATED APPLICATIONS

The present application claims priority under 35 U.S.C. §119 of Korean Patent Application No. 10-2015-0159880, filed on Nov. 13, 2015, the entire contents of which are hereby incorporated by reference.

### TECHNICAL FIELD

The present disclosure herein relates to an information processing system and an information processing method thereof.

### DESCRIPTION OF THE RELATED ART

According to development of technology of a wireless data network and the Internet of things (IoT), life log devices based on various sensing devices are being developed. The life log is a service for arranging and preserving user's daily life records. A user may directly store photos, videos, and memos in a life log device. Besides, the life log device may also store systematic records obtained by analyzing position information and biometric information. Such information may be collected by a digital device-mounted sensor and a global positioning system (GPS), etc.

An information processing system may receive various pieces of sensing information from sensing devices. The information processing system may store and process the sensing information to provide it to a user. The respective sensing devices may operate according to different rules. Accordingly, it is difficult to integrate and manage the sensing information received from the life log devices.

### SUMMARY

The present disclosure provides an information processing system and an information processing method thereof for integrating and processing life log data, which is received from various sensing devices and has common meaning.

In some example embodiments, an information processing method of an information processing system, that comprises a data storage, the information processing method comprising: receiving data from each of a plurality of sensing devices, the received data comprising sensing information and an identifier, obtaining a profile of each of the plurality of sensing devices from a manufacturer of each of the plurality of sensing devices with reference to the identifier, storing metadata in the data storage, the metadata being related to the received data and the profile, and outputting, in response to an output request for data stored in the data storage, the stored data comprising at least first data with reference to the metadata, wherein outputting the stored data comprises, reading a code that is allocated to first information corresponding to the first data, the code being read from among a plurality of codes that is stored in the data storage and outputting second data together with the first data, when the second data is stored in the data storage and second sensing information corresponding to the second data is allocated with an identical code to the read code.

In some example embodiments, the method further comprises storing the plurality of codes in the data storage before the receiving of the data from each of the plurality of sensing devices.

In some example embodiments, the plurality of codes is updated by a user.

In some example embodiments, the profile comprises device information on each of the plurality of sensing devices, and the profile further comprises a type of the sensing information measured by each of the plurality of sensing devices.

In some example embodiments, outputting the stored data further comprises outputting the first data when the second data is not stored in the data storage.

In some example embodiments, the output request is provided from an outside of the information processing system, or is generated for each set period.

In some example embodiments, each of the plurality of sensing devices is a life log measurement device for collecting biometric information and behavior information.

In some example embodiments, an information processing system comprises: a data collecting unit configured to, receive, from a sensing device, sensing data comprising sensing information and an identifier, and process the received sensing data on a basis of integrated types, a data analyzing unit configured to, receive the identifier from the data collecting unit, obtain a profile of the sensing device from a manufacturer of the sensing device with reference to the identifier, and generate metadata for the profile, and a data storage unit configured to store the sensing data processed on the basis of the integrated types, and store the metadata, wherein the data analyzing unit is further configured to, output at least first data with reference to the metadata, read a code, from among a plurality of codes stored in the data storage unit, allocated to first sensing information corresponding to the first data, search second sensing information corresponding to second data having a code identical to the read code, and output, in response to the second sensing information being searched, the second data together with the first data.

In some example embodiments, the data collecting unit is further configured to, recognize a memory position, at which the sensing information is stored, in the data storage unit, generate position information for the memory position, and store the position information together with the metadata.

In some example embodiments, the identifier comprises uniform resource identifier (URI).

In some example embodiments, each of the plurality of codes is reference standard data given by matching information expressed with synonyms.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram illustrating sensing devices and an information processing system according to an example embodiment;

FIG. 2 is a block diagram illustrating the data analyzing unit of FIG. 1 in detail;

FIG. 3 is a flowchart illustrating a data storing method according to an example embodiment; and

FIG. 4 is a flowchart illustrating a data processing method according to an example embodiment.

### DETAILED DESCRIPTION OF EMBODIMENTS

Advantages and features of the present invention, and methods for achieving the same will be cleared with reference to exemplary embodiments described later in detail together with the accompanying drawings. However, the present invention is not limited to the following exemplary embodiments, but realized in various forms. In other words, the present exemplary embodiments are provided just to complete disclosure the present invention and make a person having an ordinary skill in the art understand the scope of the invention. The present invention should be defined by only the scope of the accompanying claims. Throughout this specification, like numerals refer to like elements.

The terms and words used in the following description and claims are to describe embodiments but are not limited the inventive concept. As used herein, the singular forms “a,” “an” and “the” are intended to include the plural forms as well, unless the context clearly indicates otherwise. It will be further understood that the terms “comprises” and/or “comprising” used herein specify the presence of stated components, operations and/or elements but do not preclude the presence or addition of one or more other components, operations and/or elements.

Example embodiments are described herein with reference to cross-sectional views and/or plan views that are schematic illustrations of example embodiments. In the drawings, the thicknesses of layers and regions are exaggerated for clarity. As such, variations from the shapes of the illustrations as a result, for example, of manufacturing techniques and/or tolerances, are to be expected. Thus, example embodiments should not be construed as limited to the particular shapes of regions illustrated herein but may be to include deviations in shapes that result, for example, from manufacturing. For example, an implanted region illustrated as a rectangle may, typically, have rounded or curved features. Thus, the regions illustrated in the figures are schematic in nature and their shapes may be not intended to illustrate the actual shape of a region of a device and are not intended to limit the scope of example embodiments.

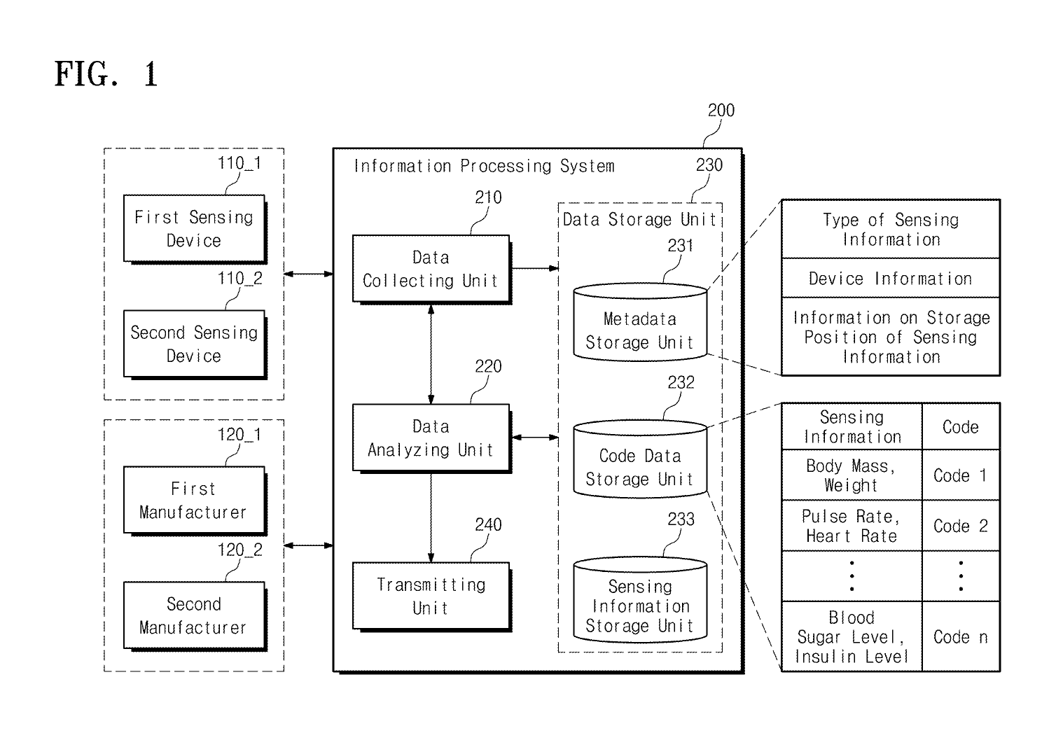

FIG. 1 is a block diagram illustrating sensing devices and an information processing system according to an example embodiment. Referring to FIG. 1, sensing devices 110_1 and 110_2 for collecting life log data, for example, biometric information and behavior information are present outside an information processing system 200.

For example, the sensing devices 110_1 and 110_2 may be used by one user. The sensing devices 110_1 and 110_2 may measure body information on the user. The sensing devices 110_1 and 110_2 may output sensing data to the information processing system 200. The sensing devices 110_1 and 110_2 may operate according to different rules. Due to such a reason, even if the sensing devices 110_1 and 110_2 measure body information having the same meaning, the measured body information may be expressed with different terms. The information processing system 200 may provide, to the user, body information having identical or similar meaning, which is included in the sensing data received from each of the sensing devices 110_1 and 110_2.

The sensing devices 110_1 and 110_2 may be at least one of a personal computer, a smart phone, smart glasses, a smart watch, a body mass index (BMI) device, weighing machine, a body fat measuring device, a diabetes measuring device, a heart rate measuring device, and a blood pressure measuring device. The foregoing devices are just examples for explaining the inventive concept, and the sensing device 110_1 and 110_2 according to the inventive concept may be realized with various life log devices. The sensing devices 110_1 and 110_2 may output measured data to the information processing system 200.

The data measured by the sensing devices 110_1 and 110_2 may include identifiers, which represent positions of respective manufacturers thereof. For example, the positions of the manufacturers may be electronic positions of information processing systems possessed by the manufacturers, such as domain names or IP addresses of manufacturers' web servers. The identifier may be a value indicating the position of the manufacturer. For example, the identifier may be a uniform resource identifier (URI) indicating the electronic position of the manufacturer.

The manufacturers 120_1 and 120_2 supplying the sensing devices 110_1 and 110_2 may communicate with the information processing system 200. For example, the first manufacturer 120_1 may be a company for manufacturing the first sensing device 110_1. The second manufacturer 120_2 may be a company for manufacturing the second sensing device 110_2. The foregoing is just an example for explaining the inventive concept and does not limit the inventive concept. When a request from the information processing system 200 is received, the manufacturers 120_1 and 120_2 may provide profiles for the sensing devices 110_1 and 110_2. The profiles may include a type of the sensing information measured by each of the sensing devices 110_1 and 110_2 and device information on each of the sensing devices 110_1 and 110_2.

The information processing system 200 may receive data from the sensing devices 110_1 and 110_2. The information processing system 200 may process the received data. The information processing system 200 may include a data collecting unit 210, a data analyzing unit 220, a data storage unit 230 and a transmitting unit 240.

The data collecting unit 210 may receive data from the sensing devices 110_1 and 110_2. The data collecting unit 210 may model the received data. The data collecting unit 210 models the data to integrate and manage data, which is received from the different sensing devices 110_1 and 110_2 and has different formats. The data received from the data collecting unit 210 may include identifiers and sensing information. The data collecting unit 210 may model the received data and may store the modeled result in the data storage unit 230. For example, the data collecting unit 210 may store the sensing information in the data storage unit 230. For example, the sensing information may be stored in a sensing information storage unit 233 of the data storage unit 230. The data modeling by the data collecting unit 210 will be described in detail with reference to the following drawings.

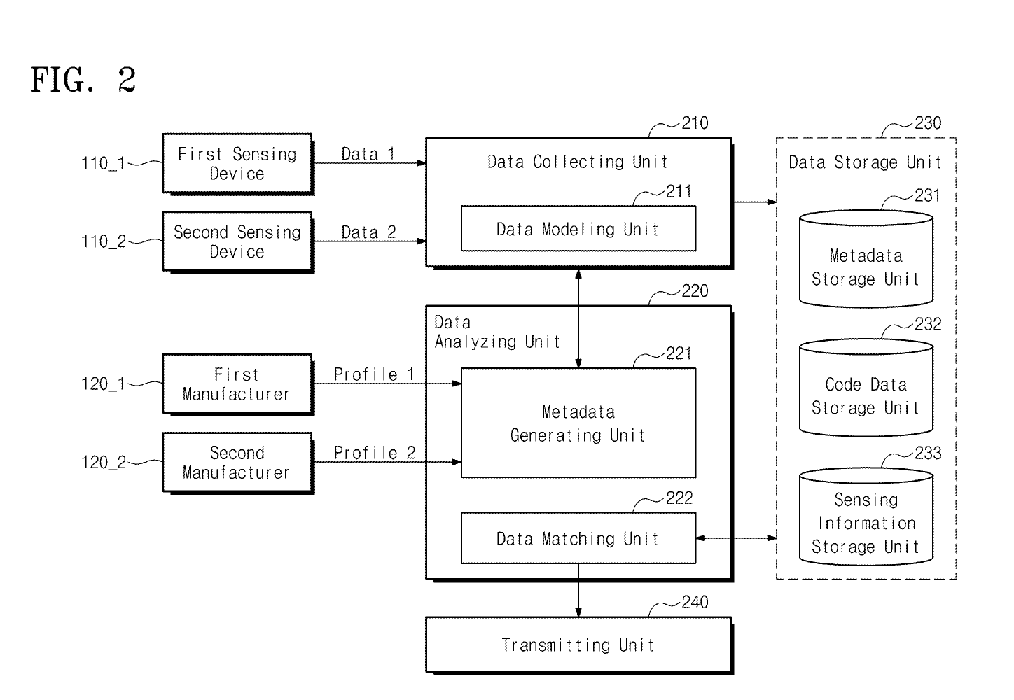

The data collecting unit 210 outputs the identifiers to the data analyzing unit 220. In addition, the data collecting unit 210 receives metadata for profiles of the sensing devices 110_1 and 110-2 from the data analyzing unit 220. The data collecting unit 210 may store the metadata in the data storage unit 230. For example, the metadata may be stored in a metadata storage unit 231 of the data storage unit 230. The data collecting unit 210 may recognize information on a memory position at which sensing information corresponding to the metadata is stored in the sensing information storage unit 230. For example, the memory position may mean a physical address or a logical address in a memory. The data collecting unit 20 may include the recognized position information in the metadata. For example, the position information in the memory for storing the sensing information may be stored in the metadata storage unit 231. A description thereabout will be described in detail through FIG. 2.

The data analyzing unit 220 may receive the identifiers from the data collecting unit 210. The data analyzing unit 220 may access the manufacturers 120_1 and 120_2 with reference to the identifiers. The data analyzing unit 220 receives the profiles for the respective sensing devices 110_1 and 110_2 from the manufacturers 120_1 and 120_2. The data analyzing unit 220 generates the metadata on the basis of the profiles for the sensing devices 110_1 and 110_2. The data analyzing unit 220 may transmit the generated metadata to the data collecting unit 210. When the storage of the sensing information is completed, the data analyzing unit 220 may perform a data processing operation for outputting the sensing information.

The data storage unit 230 may be a nonvolatile memory. For example, the nonvolatile memory device includes read only memory (ROM), programmable ROM (PROM), Electrically Programmable ROM (EPROM), Electrically Erasable and Programmable ROM (EEPROM), Flash memory, Phase-change RAM (PRAM), Magnetic RAM (MRAM), Resistive RAM (RRAM), Ferroelectric RAM (FRAM), or the like. For example, the data storage unit 230 may include a metadata storage unit 231, a code data storage unit 232, and a sensing information storage unit 233.

The metadata storage unit 231 may store the metadata for playing a role of an index for searching for data. For example, the metadata storage unit 231 may include a type of the sensing information measured by each of the sensing devices 110_1 and 110_2 and device information on each of the sensing devices 110_1 and 110_2. In addition, the metadata storage unit 231 may include information on memory positions at which pieces of the sensing information from the sensing devices 110_1 and 110_2 are stored.

The code data storage unit 232 may store codes Code 1 to Code n, where n is an integer of 2 or greater, which is given to identical or similar information. The codes Code 1 to Code n of the code data storage unit 232 may be pre-stored data. The codes Code 1 to Code n of the code data storage unit 232 may be periodically updated. The codes Code 1 to Code n of the code data storage unit 232 may be updated by a user.

For example, since ‘body mass’ and ‘weight’ are synonyms, a first code Code 1 is given thereto. In addition, since ‘pulse rate’ and ‘heart rate’ are synonyms, a second code Code 2 is given thereto. The code data storage unit 232 may give an identical or similar code to correlated information as well as to identical or similar information. For example, since ‘blood sugar level’ and ‘insulin level’ may be correlated information, an n-th code Code n may be given thereto. The information to which codes are given is an example for explaining the inventive concept. A type of the information may vary according to the types of the sensing devices 110_1 and 110_2. In this way, the code data storage unit 232 may give the codes Code 1 to Code n to each of the sensing information represented with the synonyms and the correlated information.

Here, the codes Code 1 to Code n may be reference standard data. For example, the codes Code 1 to Code n may be a machine readable biomedical information sources (UMLS) or a systematized nomenclature of medicine (SNOMED) code. The example embodiment is not limited thereto, and the codes Code 1 to Code n may be realized with various reference standard data. In addition, the codes Code 1 to Code n may be data arbitrarily determined by a user. The codes Code 1 to Code n may be stored in a metadata type.

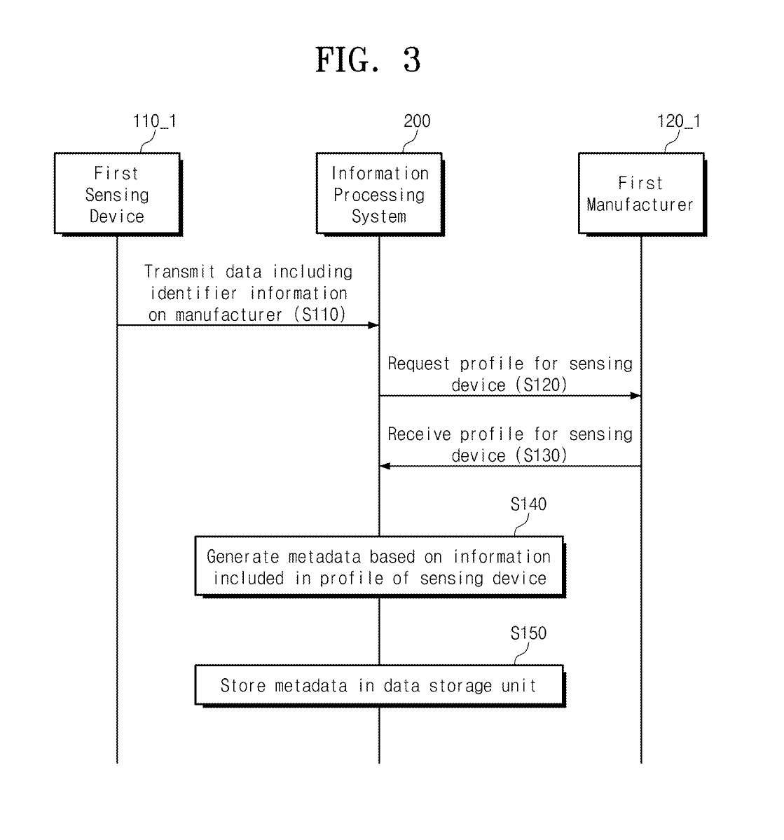

The sensing information storage unit 233 may store the sensing information detected by the sensing devices 110_1 and 110_2. A data storage method of the information processing system 200 will be described in detail with reference to FIG. 3.

After the data is stored, the information processing system 200 may receive a sensing information output request from the outside. The information processing system 200 may perform a data processing operation for processing the stored data in order to process the output request. In the data processing operation, the information processing system 200 may process the sensing information from the outside and output the processed sensing information. The example embodiment is not limited thereto and the information processing system 200 may periodically output the sensing information.

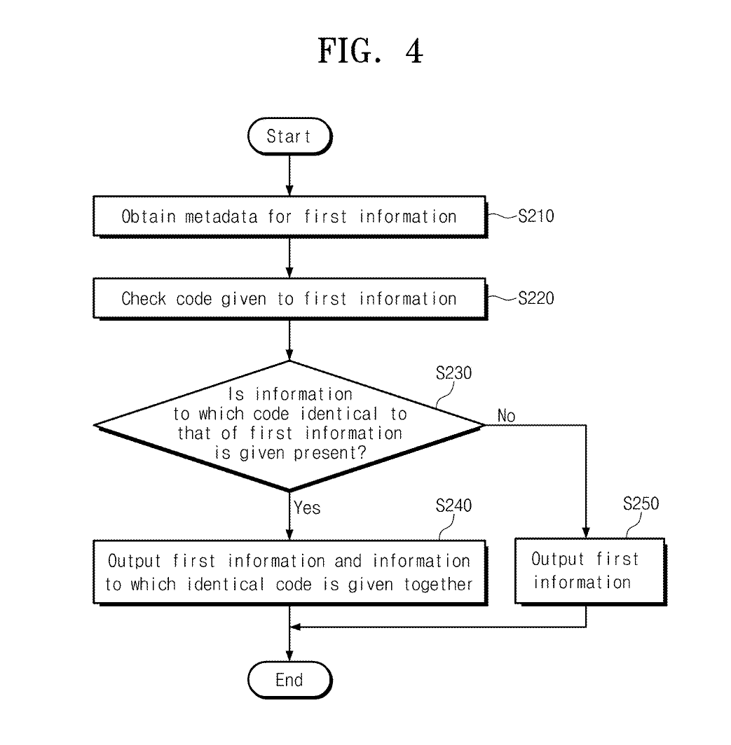

In the data processing operation, the data analyzing unit 220 may search that there is sensing information having an identical or similar code to that of the sensing information to be processed. When there is the sensing information having an identical or similar code to that of the sensing information to be processed, the data analyzing unit 220 may process data to be processed together with the information having the identical or similar code. The data analyzing unit 220 may output the information to be processed and the information having the identical or similar code to the transmitting unit 240. A description about an operation of the data analyzing unit 220 will be described in detail with reference to FIG. 2. A data processing method of the information processing system 200 will be described in detail with reference to FIG. 4.

The transmitting unit 240 may output the sensing information received from the data analyzing unit 220. The transmitting unit 240 may provide data to the user through a computer. The example embodiment is not limited thereto, and the transmitting unit 240 may transmit data to a portable device of the user through wireless communication.

The sensing devices 110_1 and 110_2 and the information processing system 200 may transmit or receive data through wireless communication. The manufacturers 120_1 and 120_2 and the information processing system 200 may transmit or receive data through wireless communication. At this point, the wireless communication may be any one of wireless wide area network (WWAN) communication (e.g. RF wireless communication, or IEEE 802.20), wireless metropolitan area network (WMAN) communication (e.g. IEEE 802.16, WiMAX), wireless local area network (WLAN) communication (e.g. NFC, BLE, WiFi, Ad-Hoc, etc.) and wireless personal area network (WPAN) communication (e.g. IEEE 802.15, ZigBee, Bluetooth, UWB, RFID, Wireless USB, Z-Wave, body area network).

Each number of the sensing devices 110_1 and 110_2 and manufacturers 120_1 and 120_2 is not limited to 2. If necessary, the sensing devices may be added. In addition, according to types of the sensing devices, the number of manufacturers, which communicate with the information processing system 200, may vary. The data collecting unit 210, the data analyzing unit 220, and the transmitting unit 240 of FIG. 1 may be realized in a hardware, software, or hybrid type.

FIG. 2 is a block diagram illustrating the data analyzing unit of FIG. 1 in detail. Referring to FIGS. 1 and 2, the data collecting unit 210 may communicate with the sensing devices 110_1 and 110_2. The data analyzing unit 220 may communicate with the manufacturers 120_1 and 120_2 of the sensing devices 110_1 and 110_2. Since the communication method has been described through FIG. 1, a detailed description will be omitted. For explanation, it is assumed that the first sensing device 110_1 may be a BMI device and the second sensing device 110_2 may be weighting machine. The example embodiment is not limited thereto.

The first sensing device 110_1 may output measured first data to the data collecting unit 210. The first data may include a first identifier, which provides position information for the manufacturer (i.e. first manufacturer 120_1) of the first sensing device 110_1. The second sensing device 110_2 may output measured second data to the data collecting unit 210. The second data may include a second identifier, which provides position information for the manufacturer (i.e. second manufacturer 120_2) of the second sensing device 110_2.

The data collecting unit 210 may include the data modeling unit 211. The data modeling unit 211 may receive the first and second data from the respective sensing devices 110_1 and 110_2. The data modeling unit 211 may process the first and second data having different formats on the basis of one integrated data model. For example, the data modeling unit 211 models each of the first and second data into a type such as a format type, an identifier, device information, and sensing information. The modeling types may be just examples for explaining the inventive concept and are not limited thereto. For example, it is assumed that the first data has a binary format and the second data has a value format. In this way, the data may be configured in various formats. The data modeling unit 211 may model the first and second data having different formats on the basis of integrated types. Accordingly, after the data modeling unit 211 may model the first and second data on the basis of the integrated types, the data collecting unit 210 transmits information on the processed data to the data collecting unit 220 and the data storage unit 230.

The data collecting unit 210 may transmit format types of the first and second data, and device information, etc., to the metadata storage unit 231. The data collecting unit 210 may store the sensing information in the sensing information storage unit 232. Finally, the data collecting unit 210 may transmit the first and second identifiers to the data collecting unit 220. The data collecting unit 210 may model the data on the basis of the integrated types in order to easily integrate and process data having different formats. In addition, the substantial analysis and process for the data are performed through the data analyzing unit 220. Accordingly, the information processing system 200 may manage the first and second data, which are received from the different sensing devices 110_1 and 110_2, in an integrated data model type.

The data analyzing unit 220 may include a metadata generating unit 221 and a data matching unit 222 in order to process and analyze data. The metadata generating unit 221 may receive the first and second identifiers from the data collecting unit 210. The metadata generating unit 221 may access the first manufacturer 120_1 with reference to the first identifier. The metadata generating unit 221 may obtain a first profile for the first sensing device 110_1 from the first manufacturer 120_1. In addition, the metadata generating unit 221 may access the second manufacturer 120_2 with reference to the second identifier. The metadata generating unit 221 may obtain a second profile for the second sensing device 110_2 from the second manufacturer 120_2.

The first and second profiles may include device information for each of the sensing devices 110_1 and 110_2 and information on the type of the sensing information. For example, the first profile may include the device information from the first sensing device 110_1 (i.e. the BMI device). The first profile may include information such as weight, blood pressure, and pulse, which are sensed by the BMI device. The second profile includes device information from the second sensing device 110_2 (i.e. weighing machine). The second profile may include body mass information sensed by the weighing machine.

The metadata generating unit 221 may generate metadata for each of the first and second data by using the first and second profiles. The metadata generating unit 221 may transmit the generated metadata to the data collecting unit 210.

The data collecting unit 210 may store the metadata in the metadata storage unit 231. The data collecting unit 210 may store the sensing information measured by the sensing devices 110_1 and 110_2 in the sensing information storage unit 233. In addition, the data collecting unit 210 may store information on a position in which the sensing information is to be stored in the metadata storage unit 231.

The data matching unit 222 of the data analyzing unit 220 may perform matching on the sensing information to be processed with sensing information identical or similar thereto. The data matching unit 222 reads metadata for the sensing information to be processed from the metadata storage unit 231. In addition, the data matching unit 222 may read a code given to the sensing information to be processed from the code data storage unit 232. When there is other sensing information having the identical or similar code, the data matching unit 222 reads, from the metadata storage unit 231, metadata for the sensing information having an identical or similar code to that of the sensing information to be processed.

For example, when the sensing information to be processed is ‘weight’, the data matching unit 222 may read metadata for the ‘weight’ from the metadata storage unit 231. In addition, the data matching unit 222 may read a code given to the ‘weight’ from the code data storage unit 232. Referring to FIGS. 1 and 2, the code given to the ‘weight’ may be the first code Code 1. The data matching unit 222 checks whether there is other sensing information to which the first code Code 1 is given.

When it is checked that the first code Code 1 is also given to the ‘body mass’, the data matching unit 222 reads the metadata for the ‘body mass’ from the metadata storage unit 231. Through the metadata for the ‘weight’, the data matching unit 222 may obtain information on a position in which the ‘weight’ information is stored. Through the metadata for the ‘body mass’, the data matching unit 222 may obtain the information on a position in which the ‘body mass’ information may be stored. Through the position information, the data matching unit 222 may read actual sensing information for ‘weight’ and ‘body mass’ from the sensing information storage unit 233. The data matching unit 222 may output the actual sensing information to the transmitting unit 240.

The data storage unit 230 may include the metadata storage unit 231, the code data storage unit 232, and the sensing information storage unit 233. Since a description regarding this has been provided with reference to FIG. 1, a detailed description will be omitted. The data modeling unit 211, the metadata generating unit 221, and the data matching unit 222 of FIG. 3 may be configured in a hardware, software, or hybrid type. However, it may be efficient to realize the data modeling unit 211, the metadata generating unit 221, and the data matching unit 222 in the software type.

FIG. 3 is a flowchart illustrating a data storing method according to an embodiment of the inventive concept. Referring to FIGS. 1 to 3, the information processing system 200 receives data from the first sensing device 110_1 (operation S110). The data includes identifier information on the manufacturer 120_1 of the first sensing device 110_1. The information processing system 200 may access the first manufacturer 120_1 through the identifier information. The information processing system 200 may request a profile for the first sensing device 110_1 from the first manufacturer 120_1 (operation S120).

The information processing system 200 may receive the profile for the first sensing device 110_1 from the first manufacturer 120_1 (operation S130). The profile may include device information on the first sensing device 110_1 and type information on the sensing information. The information processing system 200 may generate metadata on the basis of information included in the profile (operation S140). The information processing system 200 stores a metadata type in the data storage unit 230 (operation S150).

FIG. 4 is a flowchart illustrating a data storing method according to an embodiment of the inventive concept. Referring to FIGS. 2 to 4, the data analyzing unit 220 of the information processing system 200 may obtain metadata for first information in order to output the first information (operation S210). The first information may be information that an output to the outside is requested. The embodiment of the inventive concept is not limited thereto and the first information may be periodically output.

The data analyzing unit 220 may obtain a code given to the first information from the code storage unit 232 (operation S220). The data analyzing unit 220 may determine whether there is information to which a code identical or similar to that of the first information is given (operation S230). When there is information to which the code identical or similar to that of the first information is given, the data analyzing unit 220 may obtain metadata for the information to which the identical or similar code is given. The data analyzing unit 220 may output the first information together with data, which includes the information to which the code identical or similar to that of the first information is given (operation S240). When there is not the information to which the code identical or similar to that of the first information is given, the data analyzing unit 220 outputs only data including the first information (operation S250).

As described through the embodiments of the inventive concept, the information included in the data is modeled on the basis of the integrated types. In addition, an identical or similar code is given to information expressed with a synonym or having correlation. The information processing system 200 according to the embodiments of the inventive concept models data having different formats on the basis of the integrated types. In addition, the information processing system 200 may process not only the sensing information to be processed but also other sensing information having an identical or similar code to that of the sensing information to be processed.

The configuration shown in each conceptual diagram should be understood just in a conceptual view. In order to assist the understanding of the inventive concept, the type, structure, size, or the like of each element shown in the conceptual diagram is represented in an exaggerated or contracted way. The configuration implemented in practice may have a physical shape different from that shown in each conceptual diagram. Each conceptual diagram is not intended to limit the physical shape of the element.

A device configuration illustrated each block diagram is to assist in understanding the inventive concept. Each block may be formed with blocks of a smaller unit. Alternatively, the plurality of blocks may form a larger unit of blocks according to functions thereof. In other words, the technical idea of the present inventive concept is not limited to a configuration illustrated in block diagrams.

The inventive concept has been particularly shown and described with reference to preferred embodiments thereof. It will be understood that various changes in form and details may be made therein without departing from the spirit and scope of the inventive concept as defined by the appended claims. The embodiments should be considered in descriptive sense only and not for purposes of limitation.

Therefore, the scope of the inventive concept is defined not by the detailed description of the inventive concept but by the appended claims, and all differences within the scope will be construed as being included in the inventive concept.

According to embodiments of the inventive concept, an information processing system and an information processing method thereof are provided which provide data having improved data reliability by integrating and processing data, which is received from difference sensing devices and has common meaning.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An information processing method of an information processing system, that comprises a data storage, the information processing method comprising:
receiving data from each of a plurality of sensing devices, the received data comprising sensing information and an identifier;
obtaining a profile of each of the plurality of sensing devices from a manufacturer of each of the plurality of sensing devices with reference to the identifier;
storing metadata in the data storage, the metadata being related to the received data and the profile; and
outputting, in response to an output request for data stored in the data storage, the stored data comprising at least first data with reference to the metadata,
wherein outputting the stored data comprises:
reading a code that is allocated to first information corresponding to the first data, the code being read from among a plurality of codes that is stored in the data storage; and
outputting second data together with the first data, when the second data is stored in the data storage and second sensing information corresponding to the second data is allocated with an identical code to the read code.

2. The information processing method of claim 1, further comprising:
storing the plurality of codes in the data storage before the receiving of the data from each of the plurality of sensing devices.

3. The information processing method of claim 2, wherein the plurality of codes is updated by a user.

4. The information processing method of claim 1, wherein the profile comprises device information on each of the plurality of sensing devices, and
wherein the profile further comprises a type of the sensing information measured by each of the plurality of sensing devices.

5. The information processing method of claim 1, wherein outputting the stored data further comprises:
outputting the first data when the second data is not stored in the data storage.

6. The information processing method of claim 1, wherein the output request is provided from an outside of the information processing system, or is generated for each set period.

7. The information processing method of claim 1, wherein each of the plurality of sensing devices is a life log measurement device for collecting biometric information and behavior information.

8. An information processing system comprising:
a data collecting unit configured to,
receive, from a sensing device, sensing data comprising sensing information and an identifier, and
process the received sensing data on a basis of integrated types;
a data analyzing unit configured to,
receive the identifier from the data collecting unit,
obtain a profile of the sensing device from a manufacturer of the sensing device with reference to the identifier, and
generate metadata for the profile; and
a data storage unit configured to store the sensing data processed on the basis of the integrated types, and store the metadata,
wherein the data analyzing unit is further configured to,
output at least first data with reference to the metadata,
read a code, from among a plurality of codes stored in the data storage unit, allocated to first sensing information corresponding to the first data,
search second sensing information corresponding to second data having a code identical to the read code, and
output, in response to the second sensing information being searched, the second data together with the first data.

9. The information processing system of claim 8, wherein the data collecting unit is further configured to,
recognize a memory position, at which the sensing information is stored, in the data storage unit,
generate position information for the memory position, and
store the position information together with the metadata.

10. The information processing system of claim 8, wherein the identifier comprises uniform resource identifier (URI).

11. The information processing system of claim 8, wherein each of the plurality of codes is reference standard data given by matching information expressed with synonyms.
